(19) United States
(12) Patent Application Publication
(10) Pub. No.: US 2012/0251020 A1
(43) Pub. Date: Oct. 4, 2012

(54) Self-Lubricating Structure and Method of Manufacturing the Same

(76) Inventor: Gwo S. Swei, Vandalia, OH (US)

(21) Appl. No.: 13/079,515

(22) Filed: Apr. 4, 2011

(51) Int. Cl. F16C 33/10; B32B 27/18; B32B 15/08; B05D 3/02; B05D 7/14

(52) U.S. Cl. 384/13; 427/385.5; 427/409; 428/422; 428/327

(57) ABSTRACT

A self-lubricating structure such as a bearing having a low coefficient of friction, a high bearing load capability, and a low abrasiveness is provided. The self-lubricating bearing has a PTFE-based sliding layer that is deposited on a metal backing layer. The sliding layer includes a PTFE-based matrix, self-lubricating fillers such as liquid crystalline polymer, and high temperature reinforcing fiber such as carbon fiber. A method for producing the self-lubricating bearing is also provided.

### CROSS-REFERENCES

This application is also related to co-pending application Ser. No. ______ entitled, “Self-Lubricating Structure and Method of Manufacturing the Same” filed on even date with the present application by the present applicant.

### BACKGROUND

Sliding surfaces are part of a number of practical applications. Bearings are an example of a sliding layers application. Some applications are referred to as self-lubricating as they require no external application of lubrication to parts that experience friction because the lubricant is self-contained. Bearings with a polymer-based self-lubricating sliding layer are used, for example, in applications where externally supplied lubricants are ineffective or difficult to implement. Bearings having such a sliding layer include single layer bearings, bi-layer bearings, and multilayer bearings (i.e., bearings having three or more layers). A single layer bearing is, for example, a solid plastic bearing. A bi-layer bearing is, for example, a bearing with an outer metal backing and a plastic sliding layer. A multi-layer bearing typically is a bearing having a metal backing, an interlayer and a plastic sliding layer.

A useful plastic sliding layer includes polytetrafluoroethylene (PTFE). PTFE has a low coefficient of friction, high chemical resistance, and maintains sliding characteristics at temperatures of up to 260° C. In some applications, a PTFE matrix is used in combination with fillers to form composite self-lubricating bearing materials having low friction and good mechanical properties. Fillers are added typically with the goal of improving bearing load capacity, strength and wear resistance. As used herein, the term “PTFE-based bearing” refers to bearings with a self-lubricating sliding layer having a PTFE-based matrix.

An example of a single layer PTFE-based bearing material is Rulon® J, a PTFE-based composite material manufactured by Saint-Gobain Performance Plastics that can be machined to make sleeve bearings.

Generally, PTFE has poor adhesion to metals. Accordingly, in conventional bearings, many different types of interlayers have been applied to a metal backing to hold the PTFE-based sliding layer. In some applications, the interlayer serves as a reservoir for the PTFE and provides mechanical characteristics that improve the bearing's load capability and the bearing's thermal conductivity. Examples of such interlayers include a porous bronze layer sintered to the metal backing layer, a metal mesh bonded to the metallic backing layer, and a patterned structure embossed on the metal backing layer.

In some applications, the interlayer provides adhesive characteristics and bonds the backing layer with the PTFE-based sliding layer. Examples of such interlayers include a hot melt bonding film layer, and an adhesive layer.

Multilayer PTFE-based bearings combine the characteristics of the metal backing layer, which provides dimensional and structural rigidity, compact design, and high load capability, with the self-lubricating properties of the PTFE-based sliding layer. Multilayer PTFE-based bearings are generally thinner than single layer PTFE-based bearings. They can be cut into blanks and used as flat bearing strips, or rolled and formed into simple cylindrical bushes, die-cut or deep drawn.

There are various methods of manufacturing conventional multi-layer PTFE-based bearings. One method includes sintering a porous bronze interlayer onto a metal backing layer, depositing a PTFE mush including lubricating fillers on the porous bronze interlayer, applying heat and pressure to the mush to impregnate it into the porous bronze interlayer and to consolidate it. Another method includes preparing a PTFE billet filled with self-lubricating fillers, skiving the billet to produce a PTFE-based tape and applying heat and pressure to laminate a metal backing layer, a bonding film, and the PTFE-based tape. This alternative method can be modified to include the additional step of embossing a three dimensional honeycomb structure at the surface of a metal backing prior to the fabrication of the multilayer bearing. Each layer in a multilayer bearing involves at least one additional manufacturing step which in turn increases the manufacturing time and generally the cost of bearing production.

It remains desirable to have an improved PTFE-based bearing exhibiting good operating characteristics such as low coefficient of friction and high load bearing capability which is more easily and cost-effectively manufactured.

### SUMMARY

Embodiments of the present invention are directed to a self-lubricating structure such as a self-lubricating bearing with a self-lubricating sliding layer having a PTFE-based matrix and self-lubricating fillers. The self-lubricating structure exhibits good operating characteristics and is cost-effectively manufactured.

Embodiments of the invention provide a self-lubricating structure having a metal backing and a PTFE-based sliding layer directly applied to the metal backing. The composition of the sliding layer includes a PTFE-based matrix, self-lubricating fillers and high temperature fibers. The structure has a low coefficient of friction, high bearing load capability, and low abrasiveness. In some embodiments the sliding layer has a substantially uniform structure. In alternative embodiments, the sliding layer is deposited in more than one pass. In some of these alternative embodiments, the sliding layer has a varied structure.

Embodiments of the invention also provide a method of depositing the PTFE-based sliding layer directly onto the backing layer. The method includes the steps of providing a metal backing with a surface roughness Rz≧0.5 μm, and preparing a waterborne coating composition. The waterborne coating composition has a PTFE dispersion and self-lubricating fillers. The method further includes the steps of coating the composition directly on the metal backing, evaporating the water, and sintering the coating above the PTFE melting temperature. In some embodiments, the coating composition further includes fibers such as, high temperature fibers. The method provides a self-lubricating bearing having the desirable characteristics for a bearing through a process that is stream-lined and efficient.

The present invention together with the above and other advantages may best be understood from the following detailed description of the embodiments of the invention illustrated in the drawings, wherein:

### DRAWINGS

FIG. 1 is a cross-section view of a self-lubricating bearing according to principles of the invention;

FIG. 2 is illustrates processes of manufacturing the self-lubricating bearing of FIG. 1;

FIG. 3 is a flow chart of a process of manufacturing the self-lubricating bearing of FIG. 1; and

FIG. 4 is illustrates a coating composition for use in manufacturing the self-lubricating bearing of FIG. 1.

### DESCRIPTION

Embodiments of the invention provide a self-lubricating structure such as a self-lubricating bearing having a metal backing and a PTFE-based sliding layer directly applied to the metal backing. The composition of the sliding layer includes a PTFE-based matrix, self-lubricating fillers and high temperature fibers. The sliding layer enables a bearing having a low coefficient of friction, high bearing load capability, and low abrasiveness. In some embodiments, the sliding layer has a substantially uniform structure. In alternative embodiments, the sliding layer is deposited in more than one pass. In some of these alternative embodiments, the sliding layer has a varied structure.

Embodiments of the invention also provide a method of depositing the PTFE-based sliding layer directly onto the backing layer. The method includes the steps of providing a metal backing with a surface roughness Rz≧0.5 μm, and preparing a waterborne coating composition. The waterborne coating composition has a PTFE dispersion and self-lubricating fillers. The method of depositing the sliding layer further includes the steps of coating the composition directly on the metal backing, evaporating the water, and sintering the coating above the PTFE melting temperature. In some embodiments, the coating composition further includes fibers such as, high temperature fibers. The method produces a self-lubricating bearing having desirable characteristics through a process that is stream-lined and efficient.

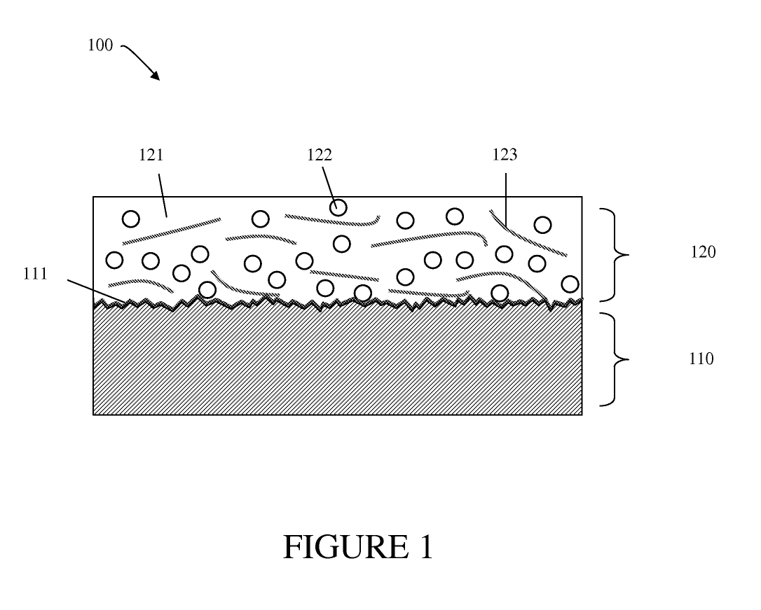

FIG. 1 shows an embodiment of a self-lubricating bearing according to principles of the invention. The self-lubricating bearing 100 is shown in cross-section. The bearing 100 includes a PTFE-based sliding layer 120 and a backing layer 110. The PTFE-based sliding layer 120 adheres to a receiving surface 111 of the backing layer 110. The backing layer 110 supports the PTFE-based sliding layer 120 and provides dimensional and structural rigidity. The backing layer 110 may be fabricated from various metals or metal alloys including steel, aluminum, stainless steel, copper alloys, and aluminum alloys. The receiving surface 111 of the backing layer 110 has a surface roughness Rz≧0.5 μm. The adhesion of the PTFE-based sliding layer 120 to the receiving surface 111 is characterized by a cross hatch adhesion rating of at least 2B based on ASTM D3359.

In a first embodiment, the PTFE-based sliding layer 120 includes, by volume, 50-95% of PTFE-based matrix 121, 4.5-50% self-lubricating fillers 122. In a second alternative embodiment, the PTFE-based sliding layer 120 further includes 0.5-30% high temperature fibers 123. In a third alternative embodiment, the high temperature fibers include high temperature organic fibers. Throughout this disclosure, the term “self-lubricating” refers to a material that exhibits lubricity and limited abrasiveness. The term “high temperature fiber” refers to a fiber-like material that can withstand the PTFE processing and sintering temperature without significantly degrading its properties. The term “high temperature organic fiber” refers to a high temperature fiber that contains the element carbon. Throughout this disclosure, the word “sintering” refers to a process where small particles under the action of heat and/or pressure are fused together to form a solid material. The self-lubricating fillers 122 are typically homogeneously distributed throughout the PTFE-based matrix 121. The composite structure and the composition of the PTFE-based sliding layer enables the bearing 100 to have a low coefficient of friction, low wear, high bearing load capability, and low abrasiveness. Low abrasiveness is desirable when the bearing is used with a soft mating surface such as aluminum. The use of self-lubricating fillers 122 reduces the wear of the PTFE-based matrix 121 without significantly increasing the coefficient of friction and abrasiveness of the PTFE-based sliding layer 122. The use of the high temperature fibers 123 such as high temperature organic fibers increases the resistance to creep and compressive strength, thus improves the bearing load capability without increasing the abrasiveness.

The PTFE-based matrix 121 is made up of 60-100% by weight PTFE. Throughout this disclosure, the term “PTFE” refers to a homopolymer of tetrafluoroethylene or a copolymer of tetrafluoroethylene with such small concentrations of copolymerizable modifying monomers where the melting point of the resultant polymer is not lower than 320° C.

In addition, the PTFE-based matrix can include 1-40 wt % high temperature melt processable polymers. Throughout this disclosure, the term “high temperature melt processable polymers” refers to a melt processable polymer that can withstand the PTFE processing and sintering temperature without significantly degrading its properties. Examples of high temperature melt processable polymers that may be used in embodiments of the invention include melt processable fluoropolymers such as fluorinated ethylene-propylene (FEP), perfluoroalkoxy polymer (PFA), monofluoroalkyl polymer (MFA), Tetrafluoroethylene-ethylene (ETFE), Polyvinylidene Fluoride (PVDF), and polychlorotrifluoroethylene (PCTFE). Other examples of high temperature melt processable polymers include polyphenylene sulfide (PPS), polyetheretherketone (PEEK), thermoplastic polyimide (TPI), polyetherimide (PEI), polyamide imide (PAI), and liquid crystal polymers (LCP). Surprisingly, the use of a high temperature melt processable polymer in the PTFE-based matrix 121 provides improved adhesion between the PTFE-based sliding layer and the receiving surface 111 on the backing 110 even though the percentage of high temperature melt processable polymer in the PTFE-based matrix is less than 20% or 15% by weight. The use of a high temperature melt processable polymer also increases the resistance to creep and load bearing capability without significantly increasing the coefficient of friction.

The self-lubricating fillers 122 can be inorganic or organic. Examples of inorganic self-lubricating fillers include calcium fluoride, magnesium fluoride, molybdenum disulfide, or other metal sulfide with a lamellar structure, boron nitride, lead oxide, lead alloys, and tin alloys. Examples of organic self-lubricating fillers include graphite, polyimide, polyphenylene sulfone, polyetheretherketone, polyamide imide, and aromatic polyester liquid crystal polymers. A wide range of size, shape and combination of self-lubricating fillers 122 are effective in embodiments of the present invention. The use of self-lubricating fillers 122 increases the wear resistance and the creep resistance without substantially increasing the coefficient of friction of the PTFE-based sliding layer 120. The use of organic self-lubricating fillers may be used when a PTFE-based sliding layer with a low abrasiveness is desirable. In one embodiment, the PTFE-based sliding layer 120 is filled with p-oxybenzoyl homopolyester, an organic self- lubricating filler characterized by a low wear, a low coefficient of friction, and a low abrasiveness towards soft mating counterparts such as aluminum, brass, or plastic. P-oxybenzoyl homopolyester powders are available from Saint-Gobain under the trade name EKONOL®, from SUMITOMO CHEMICAL COMPANY, LIMITED under the trade name Sumikasuper® E101, and from Egene Optoelectronic Materials Company, Ltd. under the trade name SUPERNOL®. In one embodiment, the PTFE-based sliding layer is made up of between 5 and 45% per volume of p-oxybenzoyl homopolyester fillers with an average particle size between 2 and 20 microns.

High temperature fibers include inorganic fibers and high temperature organic fibers. Examples of inorganic fibers that are appropriate for embodiments of the present invention include acicular inorganic fillers such as wollastonite, chopped glass fibers, ceramic fibers, metallic fibers, submicron and nano-sized inorganic whiskers, and submicron and nano-sized inorganic fibers. Example of materials used to produce inorganic fibers or whiskers that are appropriate for embodiments of the present invention includes aluminum hydroxide, aluminum oxide, aluminum nitride, titanium dioxide, titanium nitride, silicon oxide, silicon nitride whiskers, zirconium oxide, zinc oxide, and iron oxide.

Examples of high temperature organic fibers that are appropriate for embodiments of the present invention include liquid crystal polymer fibers such as KEVLAR®, aramid fiber, pitch-based carbon fibers, cellulose-based carbon fibers, polyacrylonitrile-based carbon fibers, carbon nanofibers, and carbon natotubes. High temperature organic fibers have limited impact on the abrasiveness of the PTFE-based sliding layer. The addition of high temperature organic fibers increases the compressive strength and thus the load bearing capability of the PTFE-based sliding layer. In some embodiments, the combination of high temperature organic fibers such as graphite nano fiber and self-lubricating fillers such as p-oxybenzoyl homopolyester provides bearings with high bearing load capability, but surprisingly low coefficient of friction. The high temperature organic fibers may have an aspect ratio higher than 3, 10, 50, or even 250. In some embodiments, the high temperature organic fibers may have an average length less than the thickness of the PTFE-based sliding layer. In some embodiments, the high temperature organic fibers may have an average length larger than the thickness of the PTFE-based sliding layer. In some embodiments, the high temperature organic fibers are preferentially oriented in the directions parallel to the top surface of the bearing 100. In some embodiments, the compressive strength in the direction perpendicular to the bearing surface is multiplied by two or more due to the addition of high temperature organic fibers. Alternatively, the high temperature fiber may increase the thermal conductivity of the PTFE-based sliding layer 120. This enables a reduced operating temperature of the PTFE-based sliding layer, and thus results typically in an increase of the bearing life.

Alternative embodiments of the PTFE-based sliding layer 120 also include 0-20% by volume extender fillers such as carbon black, graphite, graphene, talk, mica, iron oxide, clays, silica, calcium carbonate, titanium dioxide, alumina, iron oxide, nano-fillers, and inorganic pigments.

With regard to the backing material 110, a metal or a metal alloy such as stainless steel, aluminum, bronze, or brass may be used. The backing material is preferably able to withstand the PTFE sintering temperature. The backing material is preferably thin, has high heat conductivity to dissipate heat. The backing layer provides the bearing with dimensional and structural rigidity. In many applications, the bearings are cut, bent, or flanged. Accordingly, the backing material preferably has high yield strength (more than 50 MPA and preferably more than 150 MPA) and high modulus (more than 50 Gpa preferably 100 Gpa). The backing layer has a receiving surface 111 with a surface roughness Rz≧0.5 μm. In some embodiments, the receiving surface 111 is mechanically or chemically treated to achieve a surface roughness Rz higher than 1 micron and preferably higher than 2 microns. Examples of mechanical or chemical treatments usable to increase surface roughness in embodiments of the bearing include mechanical sandblasting, machining, brushing, acid or/and alkali etching, electro-chemical etching, zinc phosphate or zinc calcium phosphate treatment, galvanizing, and anodizing (in case of aluminum backing).

Surface treatments may also be used to modify the chemical composition of the receiving surface 111. In one embodiment, the receiving surface 111 is coated with a primer to further increase the adhesion between the metal backing 110 and the PTFE-based sliding layer 120. In another embodiment, the metal backing 110 is a bimetal having a steel core and a copper based or aluminum based bearing alloy layers. Such a bearing alloy prevents catastrophic failure of the bearing at the end of its life by exposing the bearing alloy after PTFE-based sliding layer 120 is worn. In another embodiment, the back side of the backing 110 opposite to the side with the sliding layer can also be treated to improve corrosion resistance.

In some embodiments, the PTFE-based sliding layer can be made of several layers with different compositions. In these embodiments, the sliding layer is deposited in more than one pass. In each pass, the coating has a different composition which results in a sliding layer having a varied structure.

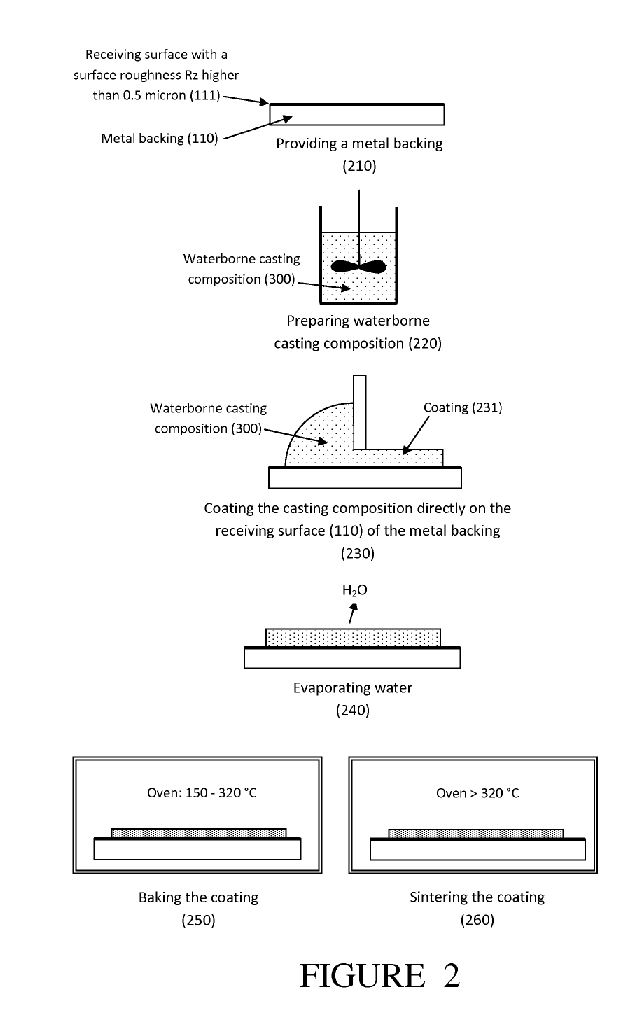

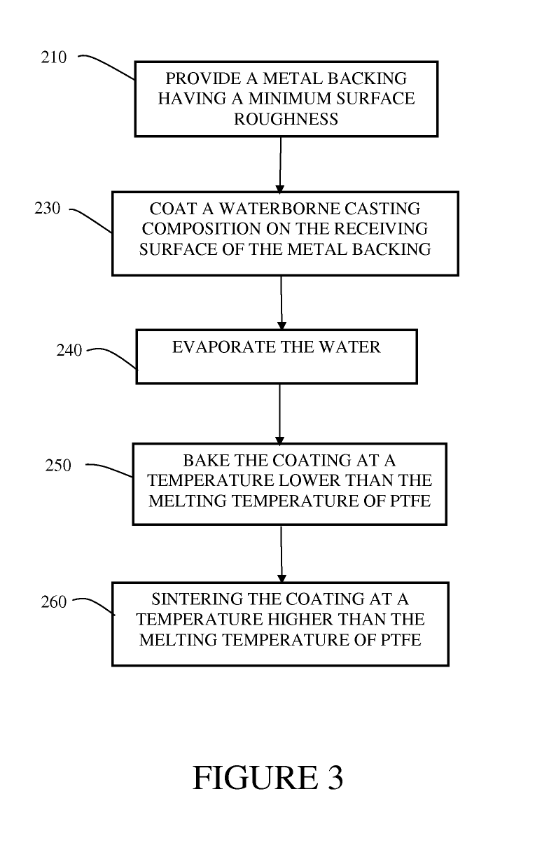

FIGS. 2 and 3 illustrate methods of manufacturing a self-lubricating structure such as a bearing with a PTFE-based sliding layer deposited on a metal backing. At step 210, a metal backing is provided. The metal backing has a receiving surface with a surface roughness Rz≧0.5 μm. The surface roughness may be accomplished through mechanical or chemical treatments. Example of these treatments include mechanical sandblasting, machining, brushing, acid or/and alkali etching, electro-chemical etching, zinc phosphate or zinc calcium phosphate treatment, galvanizing, and anodizing (in case of aluminum backing). Surface treatments may also be used to modify the chemical composition of the receiving surface 111 in order to increase adhesion. Those skilled in the art will understand that methods of providing surface roughness for the purposes of adhesion are not limited to the methods listed here.

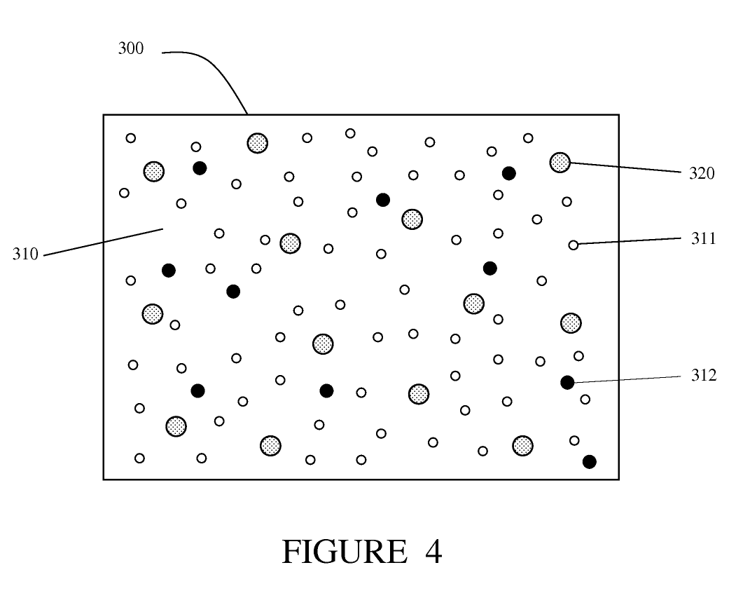

At step 220, a waterborne coating composition is prepared. This composition is described in greater detail below with regard to FIG. 4.

At step 230, the coating composition is coated directly on the receiving surface of the metal backing. Examples of coating methods include spray coating, knife over roll coating, knife over plate coating, roll coating, curtain coating, slot die coating, dip coating, and gravure coating.

At step 240, the water in the coating composition is evaporated in an oven at a temperature generally between 70 and 150° C.

At step 250, the coating layer and backing layer is baked in an oven at a temperature lower than the melting temperature of the PTFE in order to remove volatiles.

At step 260, the coating layer is then sintered in an oven at a temperature higher than the melting temperature of the PTFE.

The method enables the manufacturing of self-lubricating bearings with a PTFE-based sliding layer through a process that is streamlined and efficient. The present method of manufacture has a number of advantages including that it does not require the use of a high temperature lamination process to bond the PTFE-based sliding layer to the metal backing. The method has several other advantages that are highlighted in various embodiments described below.

In an alternative embodiment, the sliding layer is made in multiple passes. An example method of manufacture is as follows. A metal backing with a receiving surface having a surface roughness Rz≧0.5 μm is provided. A first waterborne coating composition having a fluoropolymer dispersion is coated on the receiving surface. The fluoropolymer dispersion in the first waterborne composition can be PTFE dispersion or a melt-processable fluoropolymer dispersion such as FEP. The water in the coating composition is evaporated as described above. The coating composition is then sintered above the fluoropolymer melting temperature to form a first coating. A second waterborne coating composition having a PTFE dispersion and including a self-lubricating filler dispersion is then coated on top of the first coating. The water in the second coating composition is then evaporated. The second coating is then sintered above the PTFE melting temperature to form a sliding layer. In this way, a sliding layer having a non-uniform composition may be deposited. This multiple stage method also enables a thick sliding layer to be deposited. In a further alternative embodiment, a thicker coating is deposited by repeating steps 230, 240 and 250 to deposit a coating in multiple layers and then the layers are sintered according to step 260.

FIG. 4 illustrates the waterborne coating composition 300. Throughout this disclosure, the term “waterborne coating composition” refers to a composition including water where the composition can be coated on a solid surface. The composition further includes a PTFE dispersion 311, a self-lubricating filler dispersion 320, and a liquid phase 340. The term “PTFE dispersion” refers to a dispersion of PTFE particles in a liquid. PTFE dispersions can be produced by emulsion polymerization using various methods known in the art and are available, for example, from E.I. Du Pont de Nemours and Company (DuPont) of Wilmington, Del., Asahi Company, Ltd. of Osaka, Japan, Daikin Industries, Ltd. of Osaka, Japan, and Dyneon L.L.C. of Oakdale, Minn., a subsidiary of 3M Company of Maplewood, Minn. Alternatively PTFE dispersions can be produced by dispersing fine PTFE powders in a liquid. In some embodiments, the PTFE dispersion includes PTFE particles less than 1 micron, for example, in the range of 100 to 500 nm. The term “self-lubricating filler dispersion” refers to self-lubricating fillers dispersed in a liquid.

The liquid phase 310 of the waterborne coating composition 300 includes a surfactant(s), and other additives. Surfactants are used to keep the PTFE particles and self-lubricating fillers in suspension in the liquid phase. Anionic fluorosurfactants or nonionic surfactants such as polyoxyalkylene alkyl are generally used to disperse the PTFE particles in water.

In some embodiments, the waterborne coating composition 300 includes a mixture of a PTFE dispersion 311 and one of several other polymer dispersions 312. Examples of other polymer dispersions include high temperature melt processable polymer dispersions. In one embodiment, the coating composition includes a combination of a PTFE dispersion and a FEP dispersion.

The dispersion having self-lubricating fillers can be prepared using various methods such as high shear mixing or ball milling. The choice of the surfactant to properly disperse the self-lubricating filler in water depends on the chemical nature of the self-lubricating filler. In one embodiment, the coating composition includes a dispersion of p-oxybenzoyl homopolyester fillers with an average particle size between 2 microns and 20 microns and a nonionic surfactant.

In another embodiment, the coating composition further includes a dispersion of fibers such as inorganic fibers or high temperature organic fibers. In conventional manufacturing processes that use mechanical methods, the fibers tend to be cut or otherwise damaged. The present method enables the physical integrity of the fibers to be maintained. In some embodiments, the method enables the fibers to orient preferentially in a plane parallel to the surface of the bearing. This preferential orientation resulting from the present method further increases the creep resistance of the bearing when a load is applied to the bearing in the direction perpendicular to the bearing surface.

The waterborne coating composition can further include various additives such as wetting agents to improve the coating quality, adhesion promoters, anti-foaming agents to reduce air bubble and thus improve coating quality, pigments to add color, and a viscosity modifier. In one alternative embodiment, a waterborne coating composition includes a PTFE dispersion, a self-lubricating filler dispersion, a surfactant, and a viscosity modifier. The viscosity modifier in this embodiment is prepared and the level of viscosity modifier is adjusted to have a viscosity between 100 cps and 10,000 cps.

The waterborne coating composition 300 is suitable to be directly coated on the receiving surface 111 of the metal backing 110 of the bearing. The coating is dried to evaporate water, and then baked in an oven at a temperature sufficient to remove surfactants and other volatiles. The coating is finally sintered above the melting temperature of the PTFE particles. Contrary to other thermoplastic polymers, PTFE is not melt processable. Its melting temperature corresponds to a softening point. PTFE typically has a melt creep viscosity of at least one billion Pascal-second. In some embodiments the coating is sintered above 350° C. In other embodiments the coating is sintered above 375° C.

In sum, a novel waterborne coating composition including a PTFE dispersion and self-lubricating fillers, used to produce a self-lubricating bearing with a PTFE-based sliding layer is disclosed. The method disclosed herein includes sintering the PTFE particles together when the coating is baked at a temperature above the melting temperature of the PTFE to achieve a dense coating with limited porosity without the use of high pressure. The method also enables a surprisingly high adhesion between the PTFE-based sliding layer and the metal backing without the use of a high temperature lamination process or an interlayer inner structure such as a porous bronze interlayer. In addition, it is possible to further increase the adhesion between the PTFE-based sliding layer and the metal backing if the waterborne coating composition, which is coated onto the metal backing, includes a high temperature melt processable polymer dispersion such as a FEP dispersion.

The methods disclosed herein typically enable the production of PTFE-based sliding layer with a thickness between 10 and 250 microns. A thickness less than 10 microns is possible, but may reduce the bearing product life. A thickness higher than 250 microns is also possible, if longer bearing life is desired.

In some embodiments, the PTFE sliding layer is deposited on the metal backing in several stages: one layer on top of another layer to produce a thicker PTFE-based sliding layer. It is possible to use the same or different coating compositions for each layer. In one specific example, two coating compositions are used to produce the PTFE-based sliding layer. The first coating composition includes, for example, a high temperature melt processable polymer, a PTFE dispersion, and optionally self-lubricating fillers. The first coating composition can also include a fluoropolymer dispersion such as FEP and optionally a PTFE dispersion and/or self lubricating fillers. The first coating composition is directly coated on the receiving surface of the metal backing, dried, and then sintered. The second coating composition includes a PTFE dispersion, self-lubricating fillers, and optionally high temperature fibers. The second coating composition is coated on the first layer, dried, and finally sintered. The process can be repeated several times to build the thickness of the PTFE-based sliding layer.

The methods disclosed herein were evaluated at the lab scale to apply the coating composition on a metal foil. The processes for coating the PTFE-based sliding layer directly onto a metal backing include spray coating, knife over roll coating, knife over plate coating, roll coating, slot die coating, dip coating, and gravure coating. The methods of the present invention are not limited to those processes listed here. One skilled in the art will understand that other coating processes are possible within the scope of the invention. The metal backing has generally a thickness in the range of 0.01 mm and 1.5 mm. In one embodiment, for ease of manufacturing, the PTFE-based sliding layer is deposited on a thin metal backing having a thickness less than 0.15 mm or preferably less than 0.075 mm. Subsequently the thin metal backing coated with the PTFE-based sliding layer can be adhered to a thicker metal backing.

The self-lubricating bearings fabricated in the methods described above may be formed into a number of different structures including a variety of bearing types. These bearing types include bushes or journal bearings, thrust washers, and skid plates. For example, bushes or journal bearings may be formed by cutting the self-lubricating bearing into strips. Each of these strips may then be formed into hollow cylinders, with the PTFE-based sliding layer positioned on the inside cylindrical surface thereof, or alternatively, on the outside surface thereof, depending on the particular application. The cylindrical bearings may then be flanged using techniques familiar to those skilled in the art such as deep drawn. In some embodiments, the self-lubricating bearing may be laminated to a rubber-like backing prior and then be formed into any number of bearing type.

There now follow examples which illustrate the invention.

### EXAMPLE 1

A waterborne dispersion of p-oxybenzoyl homopolyester particles with an average particle size of less than 10 microns available from Egene OptoElectronic Materials Company, Ltd. and a PTFE dispersion available from Dupont were mixed together to prepare a waterborne coating composition A. The relative weight ratios of p-oxybenzoyl homopolyester and PTFE in the coating composition were adjusted to provide a coating with 35 vol % p-oxybenzoyl homopolyester particles and 65 vol % PTFE.

The waterborne coating composition A was coated on a stainless steel foil, the receiving surface of the foil having a surface roughness Rz of 0.8 micron. The coating was accomplished using an 8 path wet film applicator (254 microns gap). The foil with the coating composition was then dried in an oven at 100° C. to evaporate water, and then sintered in an oven at 380° C. to produce a self-lubricating bearing having a metal backing with a PTFE-based sliding layer filled with p-oxybenzoyl homopolyester. The sliding layer had a thickness of 43 microns.

The adhesion between the PTFE-based sliding layer and the metal backing was tested using the cross-cut tape test described in ASTM D 3359-02. The adhesion was rated 5B, which is the best rating according to the ASTM method. This result was surprising because PTFE is known for its poor adhesion to other materials. This demonstrates the capability of the method according to the present embodiment to achieve good adhesion between the metal backing and the PTFE-based sliding layer.

### EXAMPLE 2

A waterborne dispersion of p-oxybenzoyl homopolyester particles and carbon fibers with an aspect ratio of 400 available from Applied Science, Inc. of Cedarville, Ohio, a PTFE dispersion, and an FEP dispersion were mixed together to prepare a waterborne coating composition B. The relative weight ratios of p-oxybenzoyl homopolyester, carbon fibers, PTFE, and FEP in the coating composition were adjusted to provide a coating with 28 vol % p-oxybenzoyl homopolyester particles, 2 vol % carbon fibers, 63 vol % PTFE, and 7 vol % FEP.

The waterborne coating composition B was coated on a stainless steel foil, the receiving surface of the foil having a surface roughness Rz of 0.8 micron. The coating was accomplished using an 8 path wet film applicator (152 microns gap). The coating on the backing layer was then dried in an oven at 100° C. to evaporate water, and then sintered in a high temperature oven at 380° C. to produce a self-lubricating bearing having a metal backing and a PTFE-based sliding layer filled with p-oxybenzoyl homopolyester and carbon fibers. The sliding layer had a thickness of 25 microns.

The adhesion between the PTFE-based sliding layer and the metal backing was tested using the cross-cut tape test described in ASTM D 3359-02. The self-lubricating bearing of this example exhibited excellent adhesion and ranked 5B according to ASTM D 3359-02.

### EXAMPLE 3

A waterborne dispersion of p-oxybenzoyl homopolyester particles and carbon nanofibers, and a PTFE dispersion were mixed together to prepare a waterborne coating composition C. The relative weight ratios of p-oxybenzoyl homopolyester, carbon fibers, and PTFE in the coating composition were adjusted to provide a coating with 27.5 vol % p-oxybenzoyl homopolyester particles, 5.5 vol % carbon fibers, and 67 vol % PTFE.

The waterborne coating composition C was coated on top of the sliding layer of example 2 using an 8 path wet film applicator (254 microns gap), dried in an oven at 100° C. to evaporate water, and then sintered in a high temperature oven at 380 C to produce a self-lubricating bearing having a metal backing and a PTFE-based sliding layer filled with p-oxybenzoyl homopolyester and carbon fibers. The sliding layer had a thickness of 68 microns.

The self-lubricating bearing of the present embodiment exhibited excellent adhesion ranked 5B according to ASTM D 3359-02.

### EXAMPLE 4

The coefficient of friction of the self-lubricating bearings of examples 1 and 3 were measured using a universal testing machine equipped with a load cell and a coefficient of friction attachment based on ASTM D1894-01. The speed of the test was 175 mm/min, the surface of the sled was 40.3 cm², and the weight of the sled was 1250 g. The mating surface was a stainless steel foil with a surface roughness Rz of 0.8 micron. The coefficient of friction of a commercially available PTFE sheet was also measured for comparison.

| | | | Commercially |
|---|---|---|---|
| | Bearing | Bearing | available |
| | example 1 | example 3 | PTFE sheet |
| Kinetic coefficient of friction | 0.08 | 0.105 | 0.19 |

The compositions with p-oxybenzoyl homopolyester (example 1) and with p-oxybenzoyl homopolyester and carbon fibers (example 3) surprisingly have a kinetic coefficient of friction equal to or better than a sample of the PTFE sheet.

### EXAMPLE 5

The self-lubricating bearing of example 1 and the self-lubricating bearing of example 3 were scratched using a plastic stylus under a pressure of 15 MPa. A deformation was exhibited in both bearing surfaces. The composition with p-oxybenzoyl homopolyester and carbon fibers (example 3) showed a smaller deformation (˜3 times smaller) and thus a better creep resistance than the composition with no carbon fibers (example 1).

Embodiments of the self-lubricating structures described herein can be used in bearing applications as well as other applications where the use of a metal foil coated with a PTFE-based coating with a low coefficient of friction and higher creep and wear resistance than pure PTFE is desirable. Examples of such applications include industrial protective coatings.

It is to be understood that the above-identified embodiments are simply illustrative of the principles of the invention. Various and other modifications and changes may be made by those skilled in the art which will embody the principles of the invention and fall within the spirit and scope thereof.

We claim:

1. A self-lubricating structure comprising:
a metal backing having a receiving surface, the receiving surface having a surface roughness Rz≧0.5 μm; and
a sliding layer directly deposited on the receiving surface wherein the sliding layer comprises:
50 to 95% per volume PTFE-based matrix comprising 60 to 100% by weight PTFE; and
5 to 50% per volume self-lubricating filler.

2. The self-lubricating structure of claim 1, wherein the self-lubricating filler comprises organic self-lubricating filler.

3. The self-lubricating structure of claim 2, wherein the organic self-lubricating filler is selected from the group consisting of graphite, polyimide, polyphenylene sulfone, aromatic polyester liquid crystal polymers, polyetheretherketone, and polyamide imide, or combinations thereof.

4. The self-lubricating structure of claim 3, wherein the organic self-lubricating filler comprises p-oxybenzoyl homopolyester filler.

5. The self-lubricating structure of claim 4, wherein the p-oxybenzoyl homopolyester filler has an average particle size between 1 and 30 microns.

6. The self-lubricating structure of claim 1, wherein the PTFE-based matrix comprises 60 to 99% by weight PTFE, and 1 to 40% by weight high temperature melt processable polymer.

7. The self-lubricating structure of claim 6, wherein the PTFE-based matrix comprises 3 to 20% by weight high temperature melt processable polymer.

8. The self-lubricating structure of claim 7, wherein the high temperature melt processable polymer is selected from the group consisting of fluorinated ethylene-propylene (FEP), perfluoroalkoxy polymer (PFA), monofluoroalkyl polymer (MFA), Tetrafluoroethylene-ethylene (ETFE), Polyvinylidene Fluoride (PVDF), and polychlorotrifluoroethylene (PCTFE), polyphenylene sulfide (PPS), polyetheretherketone (PEEK), thermoplastic polyimide (TPI), polyetherimide (PEI), polyamide imide (PAI), and liquid crystal polymers (LCP), or combinations thereof.

9. The self-lubricating structure of claim 1, wherein the receiving surface has a surface roughness Rz≧2 μm.

10. A self-lubricating bearing, comprising:
a metal backing having a receiving surface, the receiving surface having a surface roughness Rz≧0.5 μm; and
a sliding layer directly deposited on the receiving surface wherein the sliding layer comprises:
50 to 95% per volume PTFE-based matrix comprising 60 to 100% by weight PTFE;
4.5 to 50% per volume self-lubricating filler, and
0.5 to 30% per volume high temperature fibers.

11. The self-lubricating bearing of claim 10, wherein the self-lubricating filler comprises organic self-lubricating filler.

12. The self-lubricating bearing of claim 11, wherein the organic self-lubricating filler is selected from the group consisting of graphite, polyimide, polyphenylene sulfone, aromatic polyester liquid crystal polymers, polyetheretherketone, and polyamide imide, or combinations thereof.

13. The self-lubricating bearing of claim 12, wherein the organic self-lubricating filler comprises p-oxybenzoyl homopolyester filler.

14. The self-lubricating bearing of claim 13, wherein the p-oxybenzoyl homopolyester filler has an average particle size between 1 and 30 microns.

15. The self-lubricating bearing of claim 10, wherein the high temperature fibers include high temperature organic fibers.

16. The self-lubricating bearing of claim 15, wherein the high temperature organic fibers are selected from the group consisting of aramid fibers, pitch-based carbon fibers, cellulose-based carbon fibers, polyacrylonitrile-based carbon fibers, carbon nanofibers, carbon nanotubes, and graphite fibers, or combinations thereof.

17. The self-lubricating bearing of claim 10, wherein the high temperature fibers have an aspect ratio greater than 10.

18. The self-lubricating bearing of claim 17, wherein the high temperature fibers are preferentially oriented in a direction parallel to the bearing surface.

19. The self-lubricating bearing of claim 10, wherein the receiving surface has a surface roughness Rz≧2 μm.

20. The self-lubricating bearing of claim 10, wherein the PTFE-based matrix comprises 60 to 99% by weight PTFE, and 1 to 40% by weight high temperature melt processable polymer.

21. The self-lubricating bearing of claim 20, wherein the PTFE-based matrix comprises 3 to 20% by weight high temperature melt processable polymer.

22. The self-lubricating bearing of claim 21, wherein the high temperature melt processable polymer is selected from the group consisting of fluorinated ethylene-propylene (FEP), perfluoroalkoxy polymer (PFA), monofluoroalkyl polymer (MFA), Tetrafluoroethylene-ethylene (ETFE), Polyvinylidene Fluoride (PVDF), and polychlorotrifluoroethylene (PCTFE), polyphenylene sulfide (PPS), polyetheretherketone (PEEK), thermoplastic polyimide (TPI), polyetherimide (PEI), polyamide imide (PAI), and liquid crystal polymers (LCP), or combinations thereof.

23. The self-lubricating bearing of claim 20, wherein the self-lubricating filler is comprised of an organic self-lubricating filler selected from the group consisting of graphite, polyimide, polyphenylene sulfone, polyetheretherketone, polyamide imide, and aromatic polyester liquid crystal polymers, or combinations thereof.

24. The self-lubricating bearing of claim 23, wherein the organic self-lubricating filler comprises p-oxybenzoyl homopolyester filler.

25. The self-lubricating bearing of claim 24, wherein the p-oxybenzoyl homopolyester filler has an average particle size between 1 and 30 microns.

26. The self-lubricating bearing of claim 20, wherein the high temperature fiber includes high temperature organic fibers.

27. The self-lubricating bearing of claim 26, wherein the high temperature organic fibers are selected from the group consisting of aramid fibers, pitch-based carbon fibers, cellulose-based carbon fibers, polyacrylonitrile-based carbon fibers, carbon nanofibers, carbon nanotubes, and graphite fibers, or combinations thereof.

28. The self-lubricating bearing of claim 20, wherein the receiving surface has a surface roughness Rz≧2 μm.

29. The self-lubricating bearing of claim 10, wherein the sliding layer has a substantially uniform structure.

30. The self-lubricating bearing of claim 10, wherein the sliding layer has a varied structure.

31. A method of manufacturing a self-lubricating bearing, comprising:
providing a metal backing with a receiving surface having a surface roughness Rz≧0.5 μm;
preparing a waterborne coating composition comprising a PTFE dispersion and a self-lubricating filler dispersion;
coating the waterborne coating composition on the receiving surface;
evaporating water from the coated receiving surface; and
sintering the coating above the PTFE melting temperature to form a sliding layer, wherein the sliding layer comprises 50 to 95% by volume PTFE-based matrix and 5 to 50% by volume self-lubricating fillers; wherein the PTFE-based matrix comprises 60 to 100% by weight PTFE.

32. The method of claim 31, wherein the waterborne coating composition further comprises a high temperature melt processable polymer dispersion, the PTFE and high temperature melt processable polymer materials are included in the waterborne coating composition in relative amounts effective to provide a sliding layer with a PTFE-based matrix comprising 60 to 99% by weight PTFE and 1 to 40% by weight high temperature melt processable polymer.

33. The method of claim 31, wherein self-lubricating fillers are homogeneously distributed within the sliding layer.

34. The method of claim 31, wherein the self-lubricating filler is comprised of an organic self-lubricating filler selected from the group consisting of graphite, polyimide, polyphenylene sulfone, polyetheretherketone, polyamide imide, and aromatic polyester liquid crystal polymers, or combinations thereof.

35. The method of claim 34, wherein the organic self-lubricating filler comprises a p-oxybenzoyl homopolyester filler.

36. The method of claim 31, wherein the waterborne coating composition further comprises high temperature organic fibers.

37. The method of claim 31, wherein the waterborne coating composition has a viscosity between 20 and 50,000 cps.

38. The method of claim 37, wherein the waterborne coating composition has a viscosity between 100 and 10,000 cps.

39. The method of claim 31, wherein the sliding layer is formed in a plurality of stages by coating a further waterborne coating composition on top of a preceding coating.

40. A method of manufacturing a self-lubricating bearing material, comprising:
providing a metal backing with a receiving surface having a surface roughness Rz≧0.5 μm;
preparing a first waterborne coating composition comprising a fluoropolymer dispersion;
coating the first waterborne coating composition on the receiving surface;
evaporating the water in the coating composition;
sintering the coating composition above the fluoropolymer melting temperature to form a first coating;
preparing a second waterborne coating composition comprising a PTFE dispersion and a self-lubricating filler dispersion;
coating the second waterborne coating composition on the first coating;
evaporating the water in the second coating composition; and
sintering the second coating above the PTFE melting temperature to form a sliding layer.

41. The method of claim 40, wherein the sliding layer is formed in a plurality of stages by coating a further waterborne coating composition on top of a preceding sintered coating, wherein the sliding layer comprises 5 to 95% by volume PTFE-based matrix and 5 to 50% by volume self-lubricating filler and wherein the PTFE-based matrix comprises 60 to 100% by weight PTFE.

42. The self-lubricating structure of claim 41, wherein the sliding layer has a substantially uniform structure.

43. The self-lubricating structure of claim 42, wherein the sliding layer has a varied structure.
